(19) United States
(12) Patent Application Publication
(10) Pub. No.: US 2024/0283014 A1
(43) Pub. Date: Aug. 22, 2024

(54) POSITIVE ELECTRODE MATERIAL AND BATTERY

(71) Applicant: Panasonic Intellectual Property Management Co., Ltd., Osaka (JP)

(72) Inventors: Yui MASUMOTO, Osaka (JP); Yoshimasa NAKAMA, Osaka (JP)

(21) Appl. No.: 18/643,712

(22) Filed: Apr. 23, 2024

Related U.S. Application Data
(63) Continuation of application No. PCT/JP2022/033807, filed on Sep. 8, 2022.

(30) Foreign Application Priority Data
Oct. 28, 2021 (JP) 2021-176887

(51) Int. Cl. H01M 10/0562; H01M 4/02; H01M 4/131; H01M 4/505; H01M 4/525

(52) U.S. Cl. CPC H01M 10/0562; H01M 4/131; H01M 4/505; H01M 4/525; H01M 2004/028; H01M 2300/008; H01M 2300/0094

(57) ABSTRACT

A positive electrode material of the present disclosure includes a positive electrode active material and a first electrolyte that is a solid electrolyte. The first electrolyte includes Li, Nb, M1, and F. The M1 is at least one selected from the group consisting of Be, Mg, Ca, Sr, Ba, Sc, Y, Al, Ga, In, Zr, and Sn. A battery of the present disclosure includes a positive electrode, a negative electrode, and an electrolyte layer disposed between the positive electrode and the negative electrode. The positive electrode includes the positive electrode material of the present disclosure.

This application is a continuation of PCT/JP2022/033807 filed on Sep. 8, 2022, which claims foreign priority of Japanese Patent Application No. 2021-176887 filed on Oct. 28, 2021, the entire contents of both of which are incorporated herein by reference.

### BACKGROUND OF THE INVENTION

### 1. Field of the Invention

The present disclosure relates to a positive electrode material and a battery.

### 2. Description of Related Art

JP 2006-244734 A discloses a battery in which a solid electrolyte includes In as a cation and a halogen element, such as Cl, Br, or I, as an anion.

### SUMMARY OF THE INVENTION

Conventional techniques are desired to suppress an increase in the internal resistance of a battery during charge.

A positive electrode material according to an aspect of the present disclosure includes:
a positive electrode active material; and
a first electrolyte that is a solid electrolyte, wherein
the first electrolyte includes Li, Nb, M1, and F, and
the M1 is at least one selected from the group consisting of Be, Mg, Ca, Sr, Ba, Sc, Y, Al, Ga, In, Zr, and Sn.

According to the present disclosure, it is possible to suppress an increase in the internal resistance of a battery during charge.

### BRIEF DESCRIPTION OF THE DRAWINGS

FIG. 1 is a cross-sectional view schematically showing the configuration of a positive electrode material of Embodiment 1.

FIG. 2 is a cross-sectional view schematically showing the configuration of a battery of Embodiment 2.

FIG. 3 is a cross-sectional view schematically showing the configuration of a battery of Embodiment 3.

FIG. 4A shows Nyquist plots for a battery of Example 1 after charge (before storage) and after storage.

FIG. 4B shows Nyquist plots for a battery of Comparative Example 1 after charge (before storage) and after storage.

### DETAILED DESCRIPTION

### (Findings Underlying the Present Disclosure)

JP 2006-244734 A discloses an all-solid-state lithium secondary battery in which a solid electrolyte consists of a compound including In as a cation and a halogen element, such as Cl, Br, or I, as an anion. This battery is described as exhibiting favorable charge and discharge characteristics owing to its positive electrode active material having an average potential of 3.9 V or less versus Li. The above disclosure provides a description that setting the potential of the positive electrode active material versus Li to the above value can suppress the formation of a coating formed of an oxidative decomposition product, thereby enabling the battery to exhibit favorable charge and discharge characteristics. JP 2006-244734A also discloses, as positive electrode active materials having an average potential of 3.9 V or less versus Li, typical layered transition metal oxides, such as LiCoO₂ and LiNi_{0.8}Co_{0.15}Al_{0.05}O₂.

Meanwhile, the present inventors have made extensive studies on the resistance of halide solid electrolytes to oxidative decomposition. As a result, the present inventors have found that solid electrolytes exhibit various levels of resistance to oxidative decomposition depending on the types of elements contained as anions. Here, halide solid electrolytes are solid electrolytes containing a halogen element, such as F, Cl, Br, or I, as an anion.

Specifically, the present inventors have found that using, in a positive electrode material, a halide solid electrolyte including one selected from the group consisting of Cl, Br and I causes oxidative decomposition of the halide solid electrolyte during charge even with use of a positive electrode active material having an average potential of 3.9 V or less versus Li. The present inventors have also found that oxidative decomposition of such a halide solid electrolyte as above forms an oxidative decomposition product serving as a resistance layer, thus increasing the internal resistance of the battery during charge. This problem of increasing the internal resistance of the battery during charge is inferred to be due to the oxidation reaction of one element, which is selected from the group consisting of Cl, Br and I, included in the halide solid electrolyte. The oxidation reaction used herein refers to a side reaction that occurs in addition to a normal charge reaction in which lithium ions and electrons are extracted from the positive electrode active material included in the positive electrode material. In the side reaction, electrons are extracted also from the halide solid electrolyte including the one element, which is selected from the group consisting of Cl, Br and I, in contact with the positive electrode active material. The halogen element has a relatively large ionic radius, and has a small interaction force with a cationic component of the halide solid electrolyte. Probably because of this fact, the halide solid electrolyte is prone to an oxidation reaction. This oxidation reaction forms, between the positive electrode active material and the halide solid electrolyte, an oxidative decomposition layer having a poor lithium-ion conductivity. This oxidative decomposition layer serves as a high interfacial resistance in the electrode reaction of the positive electrode. This probably increases the internal resistance of the battery during charge.

The present inventors have further found that a battery in which a halide solid electrolyte including fluorine (F) is used in a positive electrode material exhibits an excellent oxidation resistance and accordingly can suppress an increase in the internal resistance of the battery during charge. Although not elucidated, the details of the mechanism are inferred as follows. F has the highest electronegativity among the halogen elements. In a halide solid electrolyte including F, F strongly bonds to the cation. This makes the halide solid electrolyte to be less prone to the progress with the oxidation reaction of F, namely, the side reaction in which electrons are extracted from F.

On the basis of the above findings, the present inventors have arrived at a positive electrode material of the present disclosure capable of suppressing an increase in the internal resistance of the battery during charge.

### (Overview of One Aspect According to the Present Disclosure)

A positive electrode material according to a first aspect of the present disclosure includes:
a positive electrode active material; and
a first electrolyte that is a solid electrolyte, wherein
the first electrolyte includes Li, Nb, M1, and F, and
the M1 is at least one selected from the group consisting of Be, Mg, Ca, Sr, Ba, Sc, Y, Al, Ga, In, Zr, and Sn.

In the positive electrode material according to the first aspect, the first electrolyte has a high oxidation resistance. This suppresses the formation of an oxidative decomposition layer between the first electrolyte and the positive electrode active material in the positive electrode. The first electrolyte also has a high ionic conductivity. This can reduce the interfacial resistance between the first electrolyte and the positive electrode active material. With the above configuration, it is therefore possible to suppress an increase in the internal resistance of the battery during charge.

In a second aspect of the present disclosure, for example, the positive electrode material according to the first aspect may be such that the positive electrode material further includes a second electrolyte having composition different from composition of the first electrolyte.

The positive electrode material according to the second aspect can achieve a higher ionic conductivity by including the second electrolyte. In addition, the first electrolyte having a high oxidation resistance can suppress oxidative decomposition of the second electrolyte. This can reduce the resistance resulting from the migration of Li ions in the positive electrode. With the above configuration, it is therefore possible to more effectively suppress an increase in the internal resistance of the battery during charge.

In a third aspect of the present disclosure, for example, the positive electrode material according to the second aspect may be such that a ratio of a mass of the first electrolyte to a mass of the positive electrode active material is smaller than a ratio of a mass of the second electrolyte to the mass of the positive electrode active material.

Even with the above configuration, it is possible to suppress an increase in the internal resistance of the battery during charge.

In a fourth aspect of the present disclosure, for example, the positive electrode material according to the second or third aspect may be such that the first electrolyte is present between the positive electrode active material and the second electrolyte.

With the above configuration, the presence of the first electrolyte having a high oxidation resistance between the positive electrode active material and the second electrolyte suppresses oxidative decomposition of the second electrolyte. This can reduce the resistance resulting from the migration of Li ions in the positive electrode. It is therefore possible to more effectively suppress an increase in the internal resistance of the battery during charge.

In a fifth aspect of the present disclosure, for example, the positive electrode material according to any one of the second to fourth aspects may be such that the second electrolyte is represented by the following composition formula (1):

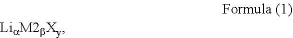

in the composition formula (1), the α, the β, and the γ are each a value greater than 0, the M2 includes at least one selected from the group consisting of metalloid elements and metal elements other than Li, and the X is at least one selected from the group consisting of F, Cl, Br, and I.

With the above configuration, the second electrolyte can have a higher ionic conductivity. This can further reduce the resistance resulting from the migration of Li ions in the positive electrode. It is therefore possible to more effectively suppress an increase in the internal resistance of the battery during charge.

In a sixth aspect of the present disclosure, for example, the positive electrode material according to the fifth aspect may be such that the M2 includes Y.

With the above configuration, the second electrolyte can have a higher ionic conductivity. This can further reduce the resistance resulting from the migration of Li ions in the positive electrode. It is therefore possible to more effectively suppress an increase in the internal resistance of the battery during charge.

In a seventh aspect of the present disclosure, for example, the positive electrode material according to the fifth or sixth aspect may be such that in the composition formula (1), 2.5≤α≤3, 1≤β≤1.1, and γ=6 are satisfied.

With the above configuration, the second electrolyte can have a higher ionic conductivity. This can further reduce the resistance resulting from the migration of Li ions in the positive electrode. It is therefore possible to more effectively suppress an increase in the internal resistance of the battery during charge.

In an eighth aspect of the present disclosure, for example, the positive electrode material according to any one of the second to fourth aspects may be such that the second electrolyte includes a sulfide solid electrolyte.

With the above configuration, the second electrolyte can have a higher ionic conductivity. This can further reduce the resistance resulting from the migration of Li ions in the positive electrode. It is therefore possible to more effectively suppress an increase in the internal resistance of the battery during charge.

In a ninth aspect of the present disclosure, for example, the positive electrode material according to any one of the second to fourth aspects may be such that the second electrolyte includes an electrolyte solution, the electrolyte solution including a lithium salt and a solvent.

With the above configuration, it is possible to suppress an increase in the internal resistance of the battery during charge.

In a tenth aspect of the present disclosure, for example, the positive electrode material according to any one of the first to ninth aspects may be such that the M1 includes Al.

With the above configuration, the first electrolyte can have a higher ionic conductivity. It is therefore possible to further suppress an increase in the internal resistance of the battery during charge.

In an eleventh aspect of the present disclosure, for example, the positive electrode material according to the tenth aspect may be such that the first electrolyte is represented by the following composition formula (2):

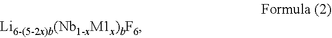

in the composition formula (2), the M1 is Al, and 0<x<1 and 0<b≤1.2 are satisfied.

With the above configuration, the first electrolyte can have a higher ionic conductivity. It is therefore possible to further suppress an increase in the internal resistance of the battery during charge.

In a twelfth aspect of the present disclosure, for example, the positive electrode material according to any one of the first to ninth aspects may be such that the M1 includes Al and at least one selected from the group consisting of Mg and Zr.

With the above configuration, the first electrolyte can have a higher ionic conductivity. It is therefore possible to further suppress an increase in the internal resistance of the battery during charge.

In a thirteenth aspect of the present disclosure, for example, the positive electrode material according to any one of the first to twelfth aspects may be such that the positive electrode active material includes a material having properties of occluding and releasing lithium ions.

With the above configuration, it is possible to enhance the energy density and charge and discharge efficiency of the battery.

In a fourteenth aspect of the present disclosure, for example, the positive electrode material according to any one of the first to thirteenth aspects may be such that the positive electrode active material includes lithium nickel cobalt manganese oxide.

With the above configuration, it is possible to enhance the energy density and charge and discharge efficiency of the battery.

A battery according to a fifteenth aspect of the present disclosure includes:
a positive electrode;
a negative electrode; and
an electrolyte layer disposed between the positive electrode and the negative electrode, wherein
the positive electrode includes the positive electrode material according to any one of the first to fourteenth aspects.

With the above configuration, it is possible to suppress an increase in the internal resistance of the battery during charge.

In a sixteenth aspect of the present disclosure, for example, the battery according to the fifteenth aspect may be such that the electrolyte layer includes, as a third electrolyte, a material having the same composition as composition of the first electrolyte.

With the above configuration, it is possible to suppress an increase in the internal resistance of the battery during charge due to oxidation of the electrolyte layer. It is therefore possible to enhance the output density and charge and discharge characteristics of the battery.

In a seventeenth aspect of the present disclosure, for example, the battery according to the fifteenth or sixteenth aspect may be such that the electrolyte layer includes, as a third electrolyte, a material having composition different from composition of the first electrolyte.

With the above configuration, it is possible to enhance the charge and discharge characteristics of the battery.

In an eighteenth aspect of the present disclosure, for example, the battery according to any one of the fifteenth to seventeenth aspects may be such that the electrolyte layer includes a first electrolyte layer and a second electrolyte layer, the first electrolyte layer is disposed between the positive electrode and the negative electrode, and the second electrolyte layer is disposed between the first electrolyte layer and the negative electrode.

With the above configuration, it is possible to suppress an increase in the internal resistance of the battery during charge.

In a nineteenth aspect of the present disclosure, for example, the battery according to the eighteenth aspect may be such that the first electrolyte layer includes, as a third electrolyte, a material having the same composition as composition of the first electrolyte.

With the above configuration, oxidative decomposition of the first electrolyte layer can be suppressed. It is therefore possible to suppress an increase in the internal resistance of the battery during charge.

In a twentieth aspect of the present disclosure, for example, the battery according to the eighteenth or nineteenth aspect may be such that the second electrolyte layer includes, as a third electrolyte, a material having composition different from composition of the first electrolyte.

With the above configuration, it is possible to enhance the charge and discharge characteristics of the battery.

Embodiments of the present disclosure will be described below with reference to the drawings.

### Embodiment 1

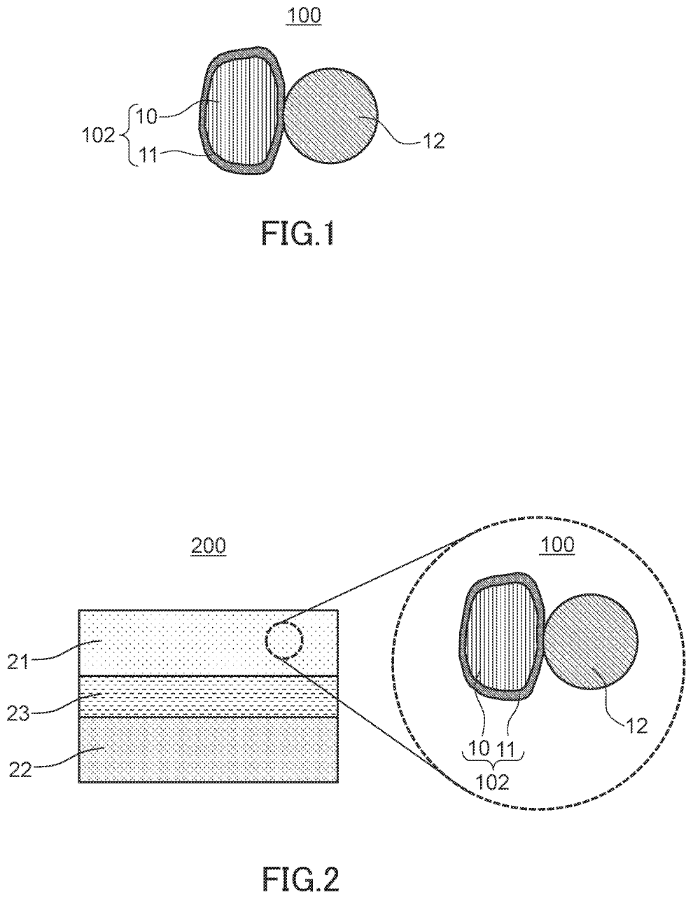

FIG. 1 is a cross-sectional view schematically showing the configuration of a positive electrode material 100 of Embodiment 1.

The positive electrode material 100 includes a positive electrode active material 10 and a first electrolyte 11 that is a solid electrolyte. The first electrolyte 11 includes Li, Nb, M1, and F. M1 is at least one selected from the group consisting of Be, Mg, Ca, Sr, Ba, Sc, Y, Al, Ga, In, Zr, and Sn.

In the positive electrode material 100, the first electrolyte 11 has a high oxidation resistance. This suppresses the formation of an oxidative decomposition layer between the positive electrode active material 10 and a different electrolyte in the positive electrode. The first electrolyte 11 also has a high ionic conductivity. It is therefore possible to reduce the interfacial resistance between the first electrolyte 11 and the positive electrode active material 10. As described above, owing to the positive electrode material 100 having not only a high oxidation resistance but also a high ionic conductivity, it is possible to suppress an increase in the internal resistance of the battery during charge.

The positive electrode material 100 may further include a second electrolyte 12 having composition different from the composition of the first electrolyte 11. The positive electrode material 100 can achieve a higher ionic conductivity by including the second electrolyte 12. In addition, the first electrolyte 11 having a high oxidation resistance can suppress oxidative decomposition of the second electrolyte 12. This can reduce the resistance resulting from the migration of Li ions in the positive electrode. With the above configuration, it is therefore possible to more effectively suppress an increase in the internal resistance of the battery during charge.

The ratio of the mass of the first electrolyte 11 to the mass of the positive electrode active material 10 may be smaller than the ratio of the mass of the second electrolyte 12 to the mass of the positive electrode active material 10. Even with the above configuration, it is possible to suppress an increase in the internal resistance of the battery during charge.

The ratio of the mass of the first electrolyte 11 to the mass of the positive electrode active material 10 in the positive electrode material 100 may be 0.01% or more and 30% or less. In the case where the ratio of the mass of the first electrolyte 11 to the mass of the positive electrode active material 10 is 0.01% or more, it is possible to suppress direct contact between the positive electrode active material 10 and the second electrolyte 12 in the positive electrode and thus suppress oxidative decomposition of the second electrolyte 12. It is therefore possible to enhance the charge and discharge efficiency of a battery using the positive electrode material 100. In the case where the ratio of the mass of the first electrolyte 11 to the mass of the positive electrode active material 10 is 30% or less, the first electrolyte 11 is not excessively large in thickness. It is therefore possible to sufficiently reduce the internal resistance of a battery using the positive electrode material 100, thereby enhancing the energy density of the battery.

The mass of the positive electrode active material 10, the mass of the first electrolyte 11, and the mass of the second electrolyte 12 can be calculated by, for example, a method described below. The positive electrode material 100 is subjected to ICP analysis to determine the element ratio for each of the positive electrode active material 10, the first electrolyte 11, and the second electrolyte 12 to calculate the mass from the element ratio determined.

The ratio of the volume of the second electrolyte 12 to the volume of the positive electrode active material 10 in the positive electrode material 100 may be 25% or more and 60% or less. In the case where the ratio of the volume of the second electrolyte 12 to the volume of the positive electrode active material 10 is 25% or more, the output characteristics of the battery can be enhanced. In the case where the ratio of the volume of the second electrolyte 12 to the volume of the positive electrode active material 10 is 60% or less, a decrease in the energy density of the battery is suppressed.

The volume of the positive electrode active material 10 and the volume of the second electrolyte 12 can be calculated by, for example, a method described below. The volume of the positive electrode active material 10 can be calculated from the mass of the positive electrode active material 10 calculated by the above method and the true density of the positive electrode active material 10. The volume of the second electrolyte 12 can be calculated from the mass of the second electrolyte 12 calculated by the above method and the true density of the second electrolyte 12. The true density of the positive electrode active material 10 and the true density of the second electrolyte 12 can be measured by, for example, a pycnometer method.

In the positive electrode material 100, the first electrolyte 11 is present between the positive electrode active material 10 and the second electrolyte 12. With the above configuration, the presence of the first electrolyte 11 having a high oxidation resistance between the positive electrode active material 10 and the second electrolyte 12 suppresses oxidative decomposition of the second electrolyte 12. This reduces the resistance resulting from the migration of Li ions in the positive electrode.

The first electrolyte 11 coats at least a portion of the surface of the positive electrode active material 10. The positive electrode active material 10 and the first electrolyte 11 constitute a coated active material 102. The first electrolyte 11 may be present on at least a portion of the surface of the positive electrode active material 10. With the above configuration, the first electrolyte 11 suppresses direct contact between the positive electrode active material 10 and the second electrolyte 12 in the positive electrode and thus suppresses oxidative decomposition of the second electrolyte 12.

The first electrolyte 11 may be present uniformly on the surface of the positive electrode active material 10. In other words, the first electrolyte 11 may uniformly coat the surface of the positive electrode active material 10. With the above configuration, the first electrolyte 11 can further suppress direct contact between the positive electrode active material 10 and the second electrolyte 12 in the positive electrode, thereby further suppressing oxidative decomposition of the second electrolyte 12. It is therefore possible to further enhance the charge and discharge characteristics of a battery using the positive electrode material 100 and suppress an increase in the internal resistance of the battery during charge.

The first electrolyte 11 may be present on only a portion of the surface of the positive electrode active material 10. In other words, the first electrolyte 11 may coat only a portion of the surface of the positive electrode active material 10. With the above configuration, the particles of the positive electrode active material 10 are in direct contact with each other through their portions that are not coated with the first electrolyte 11, thereby enhancing the electronic conductivity between the particles of the positive electrode active material 10. This enables a battery using the positive electrode material 100 to operate at a high output.

The first electrolyte 11 may coat 30% or more, 60% or more, or 90% or more of the surface of the positive electrode active material 10. The first electrolyte 11 may coat substantially the entire surface of the positive electrode active material 10.

In the case where the first electrolyte 11 is present on at least a portion of the surface of the positive electrode active material 10, the first electrolyte 11 may have a thickness of 1 nm or more and 500 nm or less. In the case where the first electrolyte 11 has a thickness of 1 nm or more, it is possible to suppress direct contact between the positive electrode active material 10 and the second electrolyte 12 in the positive electrode and thus suppress oxidative decomposition of the second electrolyte 12. It is therefore possible to enhance the charge and discharge efficiency of a battery using the positive electrode material 100. In the case where the first electrolyte 11 has a thickness of 500 nm or less, the first electrolyte 11 is not excessively large in thickness. It is therefore possible to sufficiently reduce the internal resistance of a battery using the positive electrode material 100, thereby enhancing the energy density of the battery.

The method for measuring the thickness of the first electrolyte 11 is not particularly limited. For example, a transmission electron microscope or the like can be used to directly observe the first electrolyte 11 and thus to determine the thickness. Alternatively, XPS can be conducted during which the first electrolyte 11 is etched by Ar sputtering, so that the thickness of the first electrolyte 11 can be determined from variations in the spectrum derived from the active material.

The first electrolyte 11 may be free of sulfur. With the above configuration, it is possible to prevent the generation of hydrogen sulfide gas. It is therefore possible to achieve a battery having an enhanced safety.

The first electrolyte 11 may be crystalline or may be amorphous.

The second electrolyte 12 may be a solid electrolyte.

The second electrolyte 12 may be represented by the following composition formula (1):

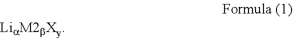

In composition formula (1), α, β, and γ re each a value greater than 0, M2 includes at least one selected from the group consisting of metalloid elements and metal elements other than Li, and X is at least one selected from the group consisting of F, Cl, Br, and I.

With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

In the present disclosure, the “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se). That is, the “metalloid elements” and the “metal elements” are each a group of elements that can become a cation when forming an inorganic compound together with a halogen element.

In the second electrolyte 12, M2 may include Y That is, the second electrolyte 12 may include Y as a metal element. With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

In the composition formula (1), 2.5≤α≤3, 1≤β≤1.1, and γ=6 may be satisfied. With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

The second electrolyte 12 including Y may be represented by, for example, a composition formula Liₐ₁M3_{b5}Y_{c}X₆, where a1+m3b5+3c=6 and c>0 are satisfied, M3 is at least one selected from the group consisting of metalloid elements and metal elements other than Li or Y, and m3 is the valence of M3.

M3 may be at least one selected from the group consisting of Mg, Ca, Sr, Ba, Zn, Sc, Al, Ga, Bi, Zr, Hf, Ti, Sn, Ta, and Nb.

With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

In the second electrolyte 12, X may include F. In the case where X includes F, the second electrolyte 12 may have a lower oxidation resistance than the first electrolyte 11 has. The second electrolyte 12 having such a low oxidation potential is obtained by, for example, adding an element that lowers the oxidation potential of F. With the above configuration, the first electrolyte 11 having a higher oxidation resistance can suppress oxidative decomposition of the second electrolyte 12.

In the second electrolyte 12, X may be free of F. With the above configuration, the first electrolyte 11 including F has a higher oxidation resistance than the second electrolyte 12 free of F has. Therefore, the first electrolyte 11 having a higher oxidation resistance can suppress oxidative decomposition of the second electrolyte 12.

The second electrolyte 12 may be represented by the following composition formula (A1):

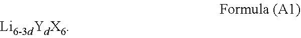

In the composition formula (A1), X is a halogen element and includes Cl, and 0<d<2 is satisfied.

The second electrolyte 12 may be represented by the following composition formula (A2):

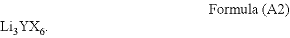

In the composition formula (A2), X is a halogen element and includes Cl.

The second electrolyte 12 may be represented by the following composition formula (A3):

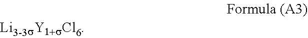

In the composition formula (A3), 0<δ≤0.15 is satisfied.

The second electrolyte 12 may be represented by the following composition formula (A4):

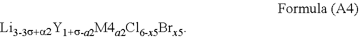

In the composition formula (A4), M4 is at least one selected from the group consisting of Mg, Ca, Sr, Ba, and Zn, and −1<δ<2, 0<a2<3, 0<(3−3δ+a2), 0<(1+δ−a2), and 0≤x5<6 are satisfied.

The second electrolyte 12 may be represented by the following composition formula (A5):

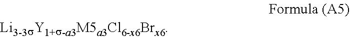

In the composition formula (A5), M5 is at least one selected from the group consisting of Al, Sc, Ga, and Bi, and −1<δ<1, 0<a3<2, 0<(1+δ−a3), and 0≤x6<6 are satisfied.

The second electrolyte 12 may be represented by the following composition formula (A6):

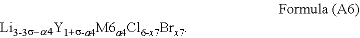

In the composition formula (A6), M6 is at least one selected from the group consisting of Zr, Hf, and Ti, and −1<δ<1, 0<a4<1.5, 0<(3−3δ−a4), 0<(1+5−a4), and 0≤x7<6 are satisfied.

The second electrolyte 12 may be represented by the following composition formula (A7):

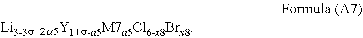

In the composition formula (A7), M7 is at least one selected from the group consisting of Ta and Nb, and −1<δ<1, 0<a5<1.2, 0<(3−3δ−2a5), 0<(1+5−a5), and 0≤x8<6 are satisfied.

The second electrolyte 12 can be, for example, Li₃YX₆, Li₂MgX₄, Li₂FeX₄, Li(Al,Ga,In)X₄, or Li₃(Al,Ga,In)X₆, where X is a halogen element and includes Cl.

In the present disclosure, when an element in a formula is expressed as, for example, “(Al,Ga,In)”, this expression indicates at least one element selected from the group of elements in parentheses. That is, “(Al,Ga,In)” is synonymous with “at least one selected from the group consisting of Al, Ga, and In”. The same applies to other elements.

With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

The second electrolyte 12 may include a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. Furthermore, LiX, Li₂O, MO_{q}, LiₚMO_{q}, or the like may be added to the above sulfide solid electrolytes. Here, X is at least one selected from the group consisting of F, Cl, Br, and I. Moreover, M is at least one selected from the group consisting of P, Si, Ge, B, Al, Ga, In, Fe, and Zn. Furthermore, the symbols p and q are each independently a natural number.

With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

The sulfide solid electrolyte may include at least one selected from the group consisting of lithium sulfide and phosphorus sulfide. With the above configuration, the second electrolyte 12 can have a higher ionic conductivity. This can further reduce the resistance resulting from the migration of Li ions in the positive electrode. It is therefore possible to more effectively suppress an increase in the internal resistance of the battery during charge.

The sulfide solid electrolyte may be Li₂S—P₂S₅.

The second electrolyte 12 may include an electrolyte solution, and the electrolyte solution includes a lithium salt and a solvent. With the above configuration, it is possible to suppress an increase in the internal resistance of the battery during charge.

The second electrolyte 12 may be the electrolyte solution including the lithium salt and the solvent.

Examples of the solvent include water, a cyclic carbonate solvent, a chain carbonate solvent, a cyclic ether solvent, a chain ether solvent, a cyclic ester solvent, a chain ester solvent, and a fluorinated solvent.

Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethylmethyl carbonate, and fluorodimethylene carbonate. One solvent selected from the above may be used alone, or a mixture of two or more solvents selected from the above may be used.

The electrolyte solution may include, as the solvent, at least one fluorinated solvent selected from the group consisting of fluoroethylene carbonate, methyl fluoropropionate, fluorobenzene, fluoroethylmethyl carbonate, and fluorodimethylene carbonate.

The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. One lithium salt selected from the above may be used alone, or a mixture of two or more lithium salts selected from the above may be used. The lithium salt has a concentration of, for example, 0.1 mol/L or more and 15 mol/L or less.

In the first electrolyte 11, the ratio of the amount of substance of Li to the sum of the amounts of substance of Nb and M1 may be 2.5 or more and 3 or less. With the above configuration, the first electrolyte 11 can have a high ionic conductivity.

In the first electrolyte 11, M1 may include Al. With the above configuration, the first electrolyte 11 can have a higher ionic conductivity. It is therefore possible to reduce the interfacial resistance between the first electrolyte 11 and the positive electrode active material 10.

In the first electrolyte 11 in which M1 includes Al, the ratio of the amount of substance of Li to the sum of the amounts of substance of Nb and Al may be 2.75 or more and 3.0 or less. With the above configuration, the first electrolyte 11 can have a high ionic conductivity.

The first electrolyte 11 may be represented by the following composition formula (2):

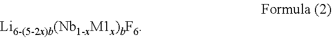

In the composition formula (2), M1 is Al, and 0<x<1 and 0<b≤1.2 are satisfied. With the above configuration, it is possible to further enhance the ionic conductivity.

In the composition formula (2), 0.35≤x≤0.5 may be satisfied.

In the composition formula (2), 0.86≤b≤0.95 may be satisfied.

With the above configuration, the first electrolyte 11 can have a higher ionic conductivity.

The first electrolyte 11 may include LiNb_{0.5}Al_{0.5}F₇. The first electrolyte 11 may include Li_{5.5}Nb_{0.8}Al_{1.2}F_{13.6}. With the above configuration, the first electrolyte 11 can have a higher ionic conductivity. It is therefore possible to reduce the interfacial resistance between the first electrolyte 11 and the positive electrode active material 10.

In the first electrolyte 11, M1 may include Al and at least one selected from the group consisting of Be, Mg, Ca, Sr, Ba, Sc, Y, Ga, In, Zr, and Sn. With the above configuration, the first electrolyte 11 can have a higher ionic conductivity.

In the first electrolyte 11, M1 may include Al and at least one selected from the group consisting of Mg and Zr. With the above configuration, the first electrolyte 11 can have a higher ionic conductivity.

In the first electrolyte 11 in which M1 includes Al and at least one selected from the group consisting of Mg and Zr, the ratio of the amount of substance of Li to the sum of the amounts of substance of Nb and M1 may be 2.5 or more and 3.0 or less. With the above configuration, the first electrolyte 11 can have a high ionic conductivity.

The first electrolyte 11 in which M1 includes Al and at least one selected from the group consisting of Mg and Zr may be represented by the following composition formula (3):

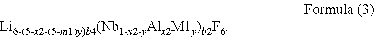

In the composition formula (3), m1 represents the valence of M1, and 0<x2<1, 0<y<1, 0<(x2+y)<1, and 0<b2≤1.2 are satisfied.

In the composition formula (3), 0.35≤x2≤0.5 may be satisfied.

In the composition formula (3), 0.35≤y≤0.5 may be satisfied.

The first electrolyte 11 may include, as an anion, an element other than F. Examples of the element included as the anion include Cl, Br, I, O, S, and Se. With the above configuration, the first electrolyte 11 can have an even higher ionic conductivity.

The positive electrode active material 10 includes a material having properties of occluding and releasing metal ions. The metal ions are typically lithium ions. The positive electrode active material 10 may include a material having properties of occluding and releasing lithium ions. With the above configuration, it is possible to enhance the energy density and charge and discharge efficiency of the battery.

Examples of the positive electrode active material 10 include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni,Co,Al)O₂, Li(Ni,Co,Mn)O₂, and LiCoO₂. In particular, in the case where the lithium-containing transition metal oxide is used as the positive electrode active material 10, it is possible to not only reduce the manufacturing cost of the positive electrode material 100 but also enhance the average discharge voltage.

The positive electrode active material 10 may include Li(Ni,Co,Mn)O₂. For example, the positive electrode active material 10 may include lithium nickel cobalt manganese oxide. The positive electrode active material having such a configuration can enhance the energy density and charge and discharge efficiency of the battery.

On at least a portion of the surface of the positive electrode active material 10, a material having composition different from the composition of the first electrolyte 11 may be present. In other words, at least a portion of the surface of the positive electrode active material 10 may be coated with a material having composition different from the composition of the first electrolyte 11. With the above configuration, the oxidation resistance of the positive electrode material 100 can be further enhanced. It is therefore possible to further suppress an increase in the internal resistance of the battery during charge.

Examples of the above material include a sulfide solid electrolyte, an oxide solid electrolyte, and a halide solid electrolyte.

The sulfide solid electrolyte for use as the above material can be any of the sulfide solid electrolytes described for the second electrolyte 12.

Examples of the oxide solid electrolyte for use as the above material include: a Li—Nb—O compound, such as LiNbO₃; a Li—B—O compound, such as LiBO₂ or Li₃BO₃; a Li—Al—O compound, such as LiAlO₂; a Li—Si—O compound, such as Li₄SiO₄; a Li—Ti—O compound, such as Li₂SO₄ or Li₄Ti₅O₁₂; a Li—Zr—O compound, such as Li₂ZrO₃; a Li—Mo—O compound, such as Li₂MoO₃; a Li—V—O compound, such as LiV₂O₅; a Li—W—O compound, such as Li₂WO₄; and a Li—P—O compound, such as Li₃PO₄.

The halide solid electrolyte for use as the above material can be any of the halide solid electrolytes described for the second electrolyte 12.

In the positive electrode material 100, the positive electrode active material 10 and the first electrolyte 11 may be separated by the above material so as not to be in direct contact with each other. With the above configuration, the oxidation resistance of the positive electrode material 100 can be further enhanced. It is therefore possible to further suppress an increase in the internal resistance of the battery during charge.

The shape of the second electrolyte 12 is not particularly limited. In the case where the second electrolyte 12 is a powdered material, its shape may be, for example, an acicular shape, a spherical shape, or an ellipsoidal shape. For example, the second electrolyte 12 may be particulate.

In the case where the second electrolyte 12 is particulate (e.g., spherical), the second electrolyte 12 may have a median diameter of 100 μm or less. In the case where the second electrolyte 12 has a median diameter of 100 μm or less, the positive electrode active material 10 and the second electrolyte 12 can form a favorable dispersion state in the positive electrode material 100. This enables the charge and discharge characteristics of a battery using the positive electrode material 100.

In the present disclosure, the median diameter means the particle diameter at a cumulative volume equal to 50% in the volumetric particle size distribution. The volumetric particle size distribution is measured with, for example, a laser diffractometer or an image analyzer.

The second electrolyte 12 may have a median diameter of 10 μm or less. With the above configuration, the positive electrode active material 10 and the second electrolyte 12 can form a more favorable dispersion state in the positive electrode material 100.

The second electrolyte 12 may have a larger median diameter than the positive electrode active material 10 has. With the above configuration, the second electrolyte 12 and the positive electrode active material 10 can form a more favorable dispersion state in the positive electrode material 100.

The positive electrode active material 10 may have a median diameter of 0.1 μm or more and 100 μm or less. In the case where the positive electrode active material 10 has a median diameter of 0.1 μm or more, the positive electrode active material 10 and the second electrolyte 12 can form a favorable dispersion state in the positive electrode material 100. This enables the charge and discharge characteristics of a battery using the positive electrode material 100. In the case where the positive electrode active material 10 has a median diameter of 100 μm or less, the diffusion rate of lithium inside the positive electrode active material 10 is enhanced. This enables a battery using the positive electrode material 100 to operate at a high output.

The positive electrode active material 10 may have a larger median diameter than the second electrolyte 12 has. With the above configuration, the positive electrode active material 10 and the second electrolyte 12 can form a favorable dispersion state in the positive electrode material 100.

As shown in FIG. 1, the second electrolyte 12 and the positive electrode active material 10 may be in contact with each other with the first electrolyte 11 therebetween. In this case, the second electrolyte 12 and the first electrolyte 11 are in contact with each other.

The positive electrode material 100 may include a plurality of particles of the positive electrode active material 10 and a plurality of particles of the second electrolyte 12.

The content of the positive electrode active material 10 and the content of the second electrolyte 12 in the positive electrode material 100, may be equal to or different from each other.

### <Method for Manufacturing First Electrolyte>

The first electrolyte 11 included in the positive electrode material 100 can be manufactured by, for example, the following method.

Raw material powders are prepared and mixed together so as to obtain a target composition. The raw material powders may be, for example, binary halides.

In an example where the target composition is Li_{3.0}Nb_{0.5}Al_{0.5}F_{7.0}, LiF, NbF₅, and AlF₃ are mixed in an approximate molar ratio of 3.0:0.5:0.5. The raw material powders may be mixed in a molar ratio adjusted in advance so as to cancel out a composition change that can occur in the synthesis process.

The raw material powders are reacted with each other mechanochemically (i.e., by mechanochemical milling) in a mixer such as a planetary ball mill to obtain a reactant. The reactant may be fired in a vacuum or in an inert atmosphere. Alternatively, the mixture of the raw material powders may be fired in a vacuum or in an inert atmosphere to obtain a reactant. The firing is conducted, for example, preferably at 100° C. or higher and 300° C. or lower for 1 hour or longer. To suppress a composition change during the firing, the raw material powders are fired preferably in a sealed container such as a quartz tube.

The first electrolyte 11 that is a solid electrolyte is thus obtained.

### <Method for Manufacturing Positive Electrode Material>

The positive electrode material 100 can be manufactured by, for example, the following method.

The positive electrode active material 10 and the first electrolyte 11 are prepared in a predetermined mass ratio. The positive electrode active material 10 is, for example, Li(Ni,Co,Mn)O₂. These two materials are put into the same reaction vessel, and a shear force is imparted to the two materials with rotating blades of an apparatus such as a dry particle composing machine, NOBILTA (manufactured by Hosokawa Micron Corporation), a high-speed flow impact machine (manufactured by Nara Machinery Co., Ltd.), or a jet mill. Alternatively, a jet stream may be used to collide the two materials with each other. In this manner, mechanical energy is imparted to the two materials, so that the coated active material 102 can be obtained in which at least a portion of the surface of the positive electrode active material 10 is coated with the first electrolyte 11.

Before impartation of the mechanical energy to the mixture of the positive electrode active material 10 and the first electrolyte 11, the mixture may be subjected to a milling process. In the milling process, a mixer such as a ball mill can be used. To suppress oxidation of the material, the milling process may be conducted in a dry inert atmosphere.

A dry particle composing method may be used to manufacture the coated active material 102. A process using the dry particle composing method includes imparting mechanical energy generated by at least one selected from the group consisting of impact, compression, and shear to the positive electrode active material 10 and the first electrolyte 11. The positive electrode active material 10 and the first electrolyte 11 are mixed in an appropriate ratio.

Next, the coated active material 102 thus obtained and the second electrolyte 12 are mixed to obtain the positive electrode material 100.

The method for mixing the coated active material 102 and the second electrolyte 12 is not particularly limited. For example, an implement such as a mortar may be used to mix the coated active material 102 and the second electrolyte 12, or a mixer such as a ball mill may be used to mix the coated active material 102 and the second electrolyte 12. The mixing ratio between the coated active material 102 and the second electrolyte 12 is not particularly limited.

### Embodiment 2

Embodiment 2 will be described below. The description overlapping that of Embodiment 1 will be omitted as appropriate.

FIG. 2 is a cross-sectional view schematically showing the configuration of a battery 200 of Embodiment 2.

The battery 200 includes a positive electrode 21, a negative electrode 22, and an electrolyte layer 23. The electrolyte layer 23 is disposed between the positive electrode 21 and the negative electrode 22. The positive electrode 21 includes the positive electrode material 100 of Embodiment 1.

With the above configuration, it is possible to suppress an increase in the internal resistance of the battery 200 during charge.

In the volume ratio “v1:100−v1” between the positive electrode active material 10 and the sum of the first electrolyte 11 and the second electrolyte 12 in the positive electrode 21, 30≤v1≤98 may be satisfied, where v1 represents the volume ratio of the positive electrode active material 10 based on 100 of the total volume of the positive electrode active material 10, the first electrolyte 11, and the second electrolyte 12 in the positive electrode 21. In the case where 30≤v1 is satisfied, a sufficient energy density of the battery 200 can be ensured. In the case where v1≤98 is satisfied, the battery 200 can operate at a high output.

The positive electrode 21 may have a thickness of 10 μm or more and 500 μm or less. In the case where the positive electrode 21 has a thickness of 10 μm or more, a sufficient energy density of the battery 200 can be ensured. In the case where the positive electrode 21 has a thickness of 500 μm or less, the battery 200 can operate at a high output.

The electrolyte layer 23 includes an electrolyte material. The electrolyte material may be, for example, a solid electrolyte. That is, the electrolyte layer 23 may be a solid electrolyte layer. The solid electrolyte that can be included in the electrolyte layer 23 is hereinafter referred to as a third electrolyte.

The third electrolyte can be the first electrolyte 11 of Embodiment 1 and/or the second electrolyte 12 of Embodiment 1.

The third electrolyte may be at least one selected from the group consisting of the first electrolyte 11 and the second electrolyte 12. That is, the electrolyte layer 23 may include, as the third electrolyte, at least one selected from the group consisting of a material having the same composition as the composition of the first electrolyte 11 and a material having the same composition as the composition of the second electrolyte 12. With the above configuration, the output density and charge and discharge characteristics of the battery 200 can be enhanced.

The third electrolyte may be the first electrolyte 11. That is, the electrolyte layer 23 may include, as the third electrolyte, a material having the same composition as the composition of the first electrolyte 11. With the above configuration, it is possible to suppress an increase in the internal resistance of the battery 200 during charge due to oxidation of the electrolyte layer 23. It is therefore possible to enhance the output density and charge and discharge characteristics of the battery 200.

The third electrolyte may be the second electrolyte 12. That is, the electrolyte layer 23 may include, as the third electrolyte, a material having the same composition as the composition of the second electrolyte 12. With the above configuration, it is possible to enhance the charge and discharge characteristics of the battery 200.

The third electrolyte may be a halide solid electrolyte, a sulfide solid electrolyte, an oxide solid electrolyte, a polymer solid electrolyte, or a complex hydride solid electrolyte.

The halide solid electrolyte for use as the third electrolyte can be any of the halide solid electrolytes described for the second electrolyte 12 in Embodiment 1.

The sulfide solid electrolyte for use as the third electrolyte can be any of the sulfide solid electrolytes described for the second electrolyte 12 in Embodiment 1.

Examples of the oxide solid electrolyte for use as the third electrolyte include: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; and glass or glass ceramics based on a Li—B—O compound, such as LiBO₂ or Li₃BO₃, to which Li₂SO₄, Li₂CO₃, or the like is added.

Examples of the polymer solid electrolyte for use as the third electrolyte include a compound of a polymer compound and a lithium salt. The polymer compound may have an ethylene oxide structure. By having an ethylene oxide structure, the polymer compound can contain a lithium salt in a large amount. This can further enhance the ionic conductivity. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one selected from the above may be used alone, or a mixture of two or more selected from the above may be used.

Examples of the complex hydride solid electrolyte for use as the third electrolyte include LiBH₄—LiI and LiBH₄—P₂S₅.

The electrolyte layer 23 may include the third electrolyte as its main component. That is, the electrolyte layer 23 may include the third electrolyte in 50% or more with respect to the entire electrolyte layer 23 on a mass basis. With the above configuration, the charge and discharge characteristics of the battery 200 can be further enhanced.

The electrolyte layer 23 may include the third electrolyte in 70% or more with respect to the entire electrolyte layer 23 on a mass basis. With the above configuration, the charge and discharge characteristics of the battery 200 can be further enhanced.

The electrolyte layer 23 may include the third electrolyte as its main component and further include unavoidable impurities, or a starting material for use in synthesizing the third electrolyte, a by-product, a decomposition product, etc.

The electrolyte layer 23 may include the third electrolyte in 100% with respect to the entire electrolyte layer 23 on a mass basis, except for unavoidably incorporated impurities. In this way, the electrolyte layer 23 may consist of the third electrolyte.

With the above configuration, the charge and discharge characteristics of the battery 200 can be further enhanced.

The electrolyte layer 23 may include two or more of the materials listed as examples of the second electrolyte 12. For example, the electrolyte layer 23 may include a halide solid electrolyte and a sulfide solid electrolyte.

The electrolyte layer 23 may have a thickness of 1 μm or more and 300 μm or less. In the case where the electrolyte layer 23 has a thickness of 1 μm or more, the positive electrode 21 and the negative electrode 22 are less prone to be short-circuited. In the case where the electrolyte layer 23 has a thickness of 300 μm or less, the battery 200 can operate at a high output.

The negative electrode 22 includes a material having properties of occluding and releasing metal ions. The metal ions are typically lithium ions. The negative electrode 22 may include a material having properties of occluding and releasing lithium ions. The material is, for example, a negative electrode active material.

Examples of the negative electrode active material include a metal material, a carbon material, an oxide, a nitride, a tin compound, and a silicon compound. The metal material may be a simple substance of metal or may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material include silicon (i.e., Si), tin (i.e., Sn), a silicon compound, and a tin compound.

The negative electrode 22 may include a solid electrolyte. The solid electrolyte can be the solid electrolyte described as the third electrolyte that can be included in the electrolyte layer 23. With the above configuration, the ionic conductivity inside the negative electrode 22 is enhanced, thereby enabling the battery 200 to operate at a high output.

The negative electrode active material may have a median diameter of 0.1 μm or more and 100 μm or less. In the case where the negative electrode active material has a median diameter of 0.1 μm or more, the negative electrode active material and the solid electrolyte can form a favorable dispersion state in the negative electrode. This enhances the charge and discharge characteristics of the battery 200. In the case where the negative electrode active material has a median diameter of 100 μm or less, the diffusion rate of lithium inside the negative electrode active material is enhanced. This enables the battery 200 to operate at a high output.

The negative electrode active material may have a larger median diameter than the solid electrolyte included in the negative electrode 22 has. With the above configuration, the negative electrode active material and the solid electrolyte can form a more favorable dispersion state in the negative electrode 22.

In the volume ratio “v2:100−v2” between the negative electrode active material and the solid electrolyte in the negative electrode 22, 30≤v2≤95 may be satisfied, where v2 represents the volume ratio of the negative electrode active material based on 100 of the total volume of the negative electrode active material and the solid electrolyte in the negative electrode 22. In the case where 30≤v2 is satisfied, a sufficient energy density of the battery 200 can be ensured. In the case where v2≤95 is satisfied, the battery 200 can operate at a high output.

The negative electrode 22 may have a thickness of 10 μm or more and 500 μm or less. In the case where the negative electrode 22 has a thickness of 10 μm or more, a sufficient energy density of the battery 200 can be ensured. In the case where the negative electrode 22 has a thickness of 500 μm or less, the battery 200 can operate at a high output.

At least one selected from the group consisting of the positive electrode 21, the negative electrode 22, and the electrolyte layer 23 may include a binder for the purpose of enhancing the adhesion between the particles.

Examples of the binder include polyvinylidene fluoride, polytetrafluoroethylene, polyethylene, polypropylene, an aramid resin, a polyamide, a polyimide, a polyamideimide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. The binder can also be a copolymer. Such a binder can be, for example, a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. The binder may be a mixture of two or more materials selected from the above.

At least one selected from the group consisting of the positive electrode 21 and the negative electrode 22 may include a conductive additive in order to reduce the electronic resistance.

The conductive additive can be, for example, graphite, such as natural graphite or artificial graphite, carbon black, such as acetylene black or Ketjenblack, a conductive fiber, such as a carbon fiber or a metal fiber, fluorinated carbon, a metal powder, such as an aluminum powder, a conductive whisker, such as a zinc oxide whisker or a potassium titanate whisker, a conductive metal oxide, such as titanium oxide, or a conductive polymer compound, such as a polyaniline compound, a polypyrrole compound, or a polythiophene compound. In the case where a conductive carbon additive is used as the conductive additive, cost reduction can be achieved.

Examples of the shape of the battery 200 include a coin type, a cylindrical type, a prismatic type, a sheet type, a button type, a flat type, and a stacked type.

### <Method for Manufacturing Battery>

The battery 200 of Embodiment 2 can be manufactured by, for example, preparing the positive electrode material 100 of Embodiment 1, a material for the electrolyte layer, and a material for the negative electrode, and producing by a known method a stack composed of the positive electrode 21, the electrolyte layer 23, and the negative electrode 22 disposed in this order.

### Embodiment 3

Embodiment 3 will be described below. The description overlapping those of Embodiments 1 and 2 will be omitted as appropriate.

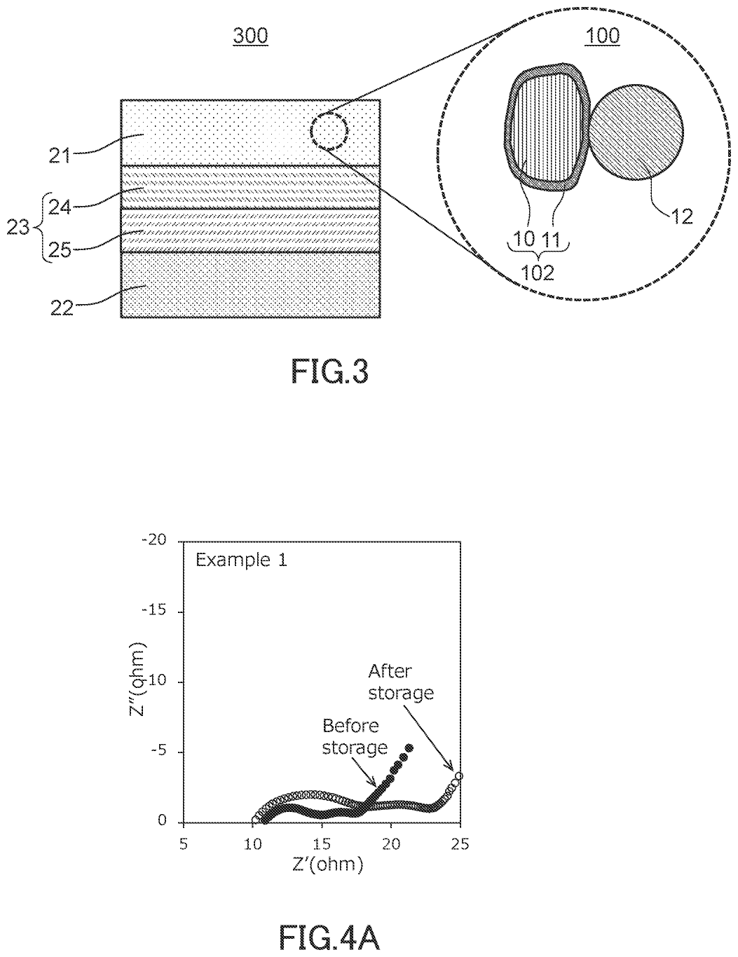

FIG. 3 is a cross-sectional view schematically showing the configuration of a battery 300 of Embodiment 3.

The battery 300 includes the positive electrode 21, the negative electrode 22, and the electrolyte layer 23. The electrolyte layer 23 includes a first electrolyte layer 24 and a second electrolyte layer 25. The first electrolyte layer 24 is disposed between the positive electrode 21 and the negative electrode 22. The second electrolyte layer 25 is disposed between the first electrolyte layer 24 and the negative electrode 22. The positive electrode 21 includes the positive electrode material 100 of Embodiment 1.

With the above configuration, it is possible to suppress an increase in the internal resistance of the battery 300 during charge.

The first electrolyte layer 24 may include, as the third electrolyte, a material having the same composition as the composition of the first electrolyte 11. With the above configuration, oxidative decomposition of the first electrolyte layer 24 can be suppressed. It is therefore possible to suppress an increase in the internal resistance of the battery 300 during charge.

The second electrolyte layer 25 may include, as the third electrolyte, a material having composition different from the composition of the first electrolyte 11. With the above configuration, it is possible to enhance the charge and discharge characteristics of the battery 300.

From the viewpoint of the reduction resistance of solid electrolytes, the third electrolyte that can be included in the first electrolyte layer 24 may have a lower reduction potential than the third electrolyte that can be included in the second electrolyte layer 25 has. With the above configuration, the third electrolyte included in the first electrolyte layer 24 can be used without being reduced. Therefore, the charge and discharge efficiency of the battery 300 can be enhanced.

The second electrolyte layer 25 may include, as the third electrolyte, a sulfide solid electrolyte. Here, the sulfide solid electrolyte included in the second electrolyte layer 25 as the third electrolyte has a lower reduction potential than the third electrolyte included in the first electrolyte layer 24 has. With the above configuration, the third electrolyte included in the first electrolyte layer 24 can be used without being reduced. Therefore, the charge and discharge efficiency of the battery 300 can be enhanced.

The first electrolyte layer 24 and the second electrolyte layer 25 each may have a thickness of 1 μm or more and 300 μm or less. In the case where the first electrolyte layer 24 and the second electrolyte layer 25 each have a thickness of 1 μm or more, the positive electrode 21 and the negative electrode 22 are less prone to be short-circuited. In the case where the first electrolyte layer 24 and the second electrolyte layer 25 each have a thickness of 300 μm or less, the battery 300 can operate at a high output.

### EXAMPLE

The present disclosure will be described below in detail with reference to an example and a comparative example.

### Example 1

### [Production of First Electrolyte]

In a glove box in an argon atmosphere with a dew point of −60° C. or lower (hereinafter referred to as “in an argon atmosphere”), raw material powders LiF, NbF₅, and AlF₃ were weighed in a molar ratio of LiF:NbF₅:AlF₃=3.0:0.5:0.5. These raw material powders were subjected to a milling process in a planetary ball mill (Type P-7 manufactured by Fritsch GmbH) at 500 rpm for 12 hours. Thus, a powder of a solid electrolyte was obtained as the first electrolyte of Example 1. The first electrolyte of Example 1 had composition represented by Li₃Nb_{0.5}Al_{0.5}F₇.

### [Production of Second Electrolyte]

In an argon atmosphere, raw material powders LiBr, YBr₃, LiCl, and YCl₃ were weighed in a molar ratio of LiBr:YBr₃:LiCl:YCl₃=1:1:5:1. These raw material powders were subjected to a milling process in a planetary ball mill (Type P-7 manufactured by Fritsch GmbH) at 600 rpm for 25 hours. Thus, a powder of a solid electrolyte was obtained as the second electrolyte of Example 1. The second electrolyte of Example 1 had composition represented by Li₃YBr₂Cl₄.

### [Production of Positive Electrode Material]

In an argon atmosphere, a positive electrode active material Li(NiCoMn)O₂ (hereinafter referred to as NCM) and the first electrolyte were weighed in a mass ratio of 100:3. These materials were put into a dry particle composing machine, NOBILTA (manufactured by Hosokawa Micron Corporation) and subjected to a composing process at 6000 rpm for 30 minutes, so that the surfaces of the particles of the positive electrode active material were coated with the first electrolyte. Thus, a coated active material of Example 1 was obtained.

In an argon atmosphere, the coated active material and the second electrolyte of Example 1 were weighed in a mass ratio of 81.55:18.45. These materials were mixed in an agate mortar. Thus, a positive electrode material of Example 1 was obtained.

### [Production of Battery]

Into an insulating cylinder having an inner diameter of 9.5 mm, 60 mg of the second electrolyte was put and pressure-molded at a pressure of 80 MPa. Thus, an electrolyte layer was formed.

Subsequently, 17.2 mg of the positive electrode material was put and pressure-molded at a pressure of 300 MPa and a temperature of 150° C. Thus, a stack composed of a positive electrode and an electrolyte layer was obtained.

Subsequently, metallic In, metallic Li, and metallic In were stacked in this order on one side of the electrolyte layer opposite to the other side in contact with the positive electrode. The metallic In and metallic Li used each had a thickness of 200 μm. These were pressure-molded at a pressure of 80 MPa. Thus, a stack composed of the positive electrode, the electrolyte layer, and a negative electrode was produced.

Subsequently, current collectors made of stainless steel were attached to the positive electrode and the negative electrode, and current collector leads were attached to the current collectors.

Lastly, an insulating ferrule was used to block the inside of the insulating cylinder from the outside air atmosphere to hermetically seal the cylinder. Thus, a battery of Example 1 was obtained.

### Comparative Example 1

In producing the positive electrode material, NCM and the second electrolyte were weighed in a mass ratio of 81.55:18.45. These materials were mixed in an agate mortar. That is, in Comparative Example 1, the surface of the positive electrode active material (NCM) was not coated with the first electrolyte. In the same manner as in Example 1 except for the above matter, a positive electrode material and a battery of Comparative Example 1 were obtained.

### (Charge Test)

The batteries of the example and the comparative example were each subjected to a charge test under the following conditions.

First, the battery was placed in a thermostatic chamber set at 85° C.

Constant-current charge was conducted at a current value of 140 μA equivalent to 0.05 C rate (20-hour rate) relative to the theoretical capacity of the battery. The end-of-charge voltage was set at 3.68 V (4.3 V vs. Li/Li⁺). Constant-voltage charge was then conducted at a voltage of 3.68 V (4.3 V vs. Li/Li⁺). The end-of-charge current was set at a current value of 28 μA equivalent to 0.01 C rate (100-hour rate).

The battery after charge was subjected to measurement using an alternating-current impedance method to obtain a Nyquist plot. The voltage amplitude was set at ±10 mV, and the frequency was set at 10⁷ Hz to 10⁻² Hz. The measurement was conducted with an electrochemical measurement system manufactured by Solartron Analytical. The waveform of the semicircular arc on the Nyquist plot was assigned to the resistance component with the positive electrode and to the resistance component with metallic Li serving as the negative electrode, and curve fitting analysis was conducted. Thus, a resistance value Rb of the positive electrode included in the battery after charge was calculated for each of Example 1 and Comparative Example 1. The results are shown in Table 1.

Subsequently, the battery was stored for 72 hours in a thermostatic chamber set at 85° C.

The battery after storage was subjected to measurement using an alternating-current impedance method in the same manner as described above to obtain a Nyquist plot. In the same manner as described above, a resistance value Ra of the positive electrode included in the battery after storage was calculated for each of Example 1 and Comparative Example 1. The increasing rate of the resistance value was calculated as Ra/Rb. The results are shown in Table 1.

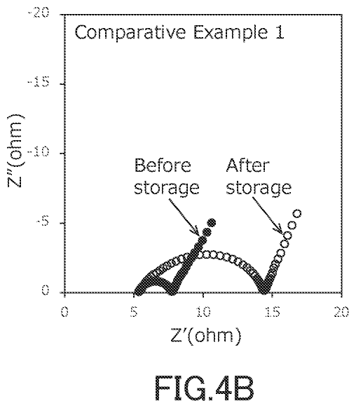

FIG. 4A and FIG. 4B respectively show the Nyquist plots for the batteries of Example 1 and Comparative Example 1 after charge (before storage) and after storage. In each of FIG. 4A and FIG. 4B, the horizontal axis represents the real part of the impedance, and the vertical axis represents the imaginary part of the impedance.

TABLE 1

| | | | Positive electrode | Positive electrode | |
|---|---|---|---|---|---|
| | First | Second | resistance value R_{b} | resistance value Rₐ | Resistance value |
| | electrolyte | electrolyte | before storage (Ω) | after storage (Ω) | increasing rate |
| Example 1 | Li₃Nb_{0.5}Al_{0.5}F₇ | Li₃YBr₂Cl₄ | 3.3 | 6.5 | 2.0 |
| Comparative | — | Li₃YBr₂Cl₄ | 2.3 | 9.5 | 4.2 |
| Example 1 | | | | | |

### <<Consideration>>

Example 1 was lower than Comparative Example 1 in terms of both the resistance value of the positive electrode after storage and the increasing rate of the resistance value. The reason for this is considered as follows; in the battery of Example 1, not only the first electrolyte had a high oxidation resistance and a high ionic conductivity, but also the first electrolyte suppressed contact between the positive electrode active material and the second electrolyte thus to suppress oxidative decomposition of the second electrolyte. In the battery of Comparative Example 1, in contrast, charging the battery caused oxidative decomposition of the second electrolyte, and the resulting oxidative decomposition product served as a resistance layer. This is considered to have increased the resistance value of the positive electrode.

Using, instead of Al, at least one selected from the group consisting of Be, Mg, Ca, Sr, Ba, Sc, Y Ga, In, Zr, and Sn, for example, Mg, Ca, Y, or Zr also promises the same effects as those in using Al. This is because an element having a formal valence of 2 or more and 4 or less and having a high ionicity has properties similar to those of Al.

In addition, the main cause of oxidative decomposition of a halide solid electrolyte is extraction of electrons from the halide solid electrolyte due to contact between the halide solid electrolyte and the positive electrode active material. According to the technique of the present disclosure, therefore, using an active material other than NCM can also achieve an effect of suppressing oxidation of a halide solid electrolyte.

As demonstrated by the above example, according to the present disclosure, it is possible to suppress an increase in the internal resistance of a battery during charge.

### INDUSTRIAL APPLICABILITY

The battery of the present disclosure can be used as, for example, an all-solid-state lithium-ion secondary battery.

What is claimed is:

1. A positive electrode material comprising:
a positive electrode active material; and
a first electrolyte that is a solid electrolyte, wherein
the first electrolyte includes Li, Nb, M1, and F, and
the M1 is at least one selected from the group consisting of Be, Mg, Ca, Sr, Ba, Sc, Y, Al, Ga, In, Zr, and Sn.

2. The positive electrode material according to claim 1, further comprising a second electrolyte having composition different from composition of the first electrolyte.

3. The positive electrode material according to claim 2, wherein a ratio of a mass of the first electrolyte to a mass of the positive electrode active material is smaller than a ratio of a mass of the second electrolyte to the mass of the positive electrode active material.

4. The positive electrode material according to claim 2, wherein the first electrolyte is present between the positive electrode active material and the second electrolyte.

5. The positive electrode material according to claim 2, wherein the second electrolyte is represented by the following composition formula (1): 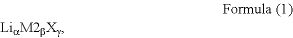
in the composition formula (1),
the α, the β, and the γ are each a value greater than 0,
the M2 includes at least one selected from the group consisting of metalloid elements and metal elements other than Li, and
the X is at least one selected from the group consisting of F, Cl, Br, and I.

6. The positive electrode material according to claim 5, wherein
the M2 includes Y.

7. The positive electrode material according to claim 5, wherein
in the composition formula (1),
2.5≤α≤3, 1≤β≤1.1, and γ=6 are satisfied.

8. The positive electrode material according to claim 2, wherein
the second electrolyte includes a sulfide solid electrolyte.

9. The positive electrode material according to claim 2, wherein
the second electrolyte includes an electrolyte solution, the electrolyte solution including a lithium salt and a solvent.

10. The positive electrode material according to claim 1, wherein
the M1 includes Al.

11. The positive electrode material according to claim 10, wherein
the first electrolyte is represented by the following composition formula (2): 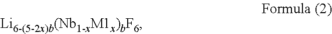
in the composition formula (2),
the M1 is Al, and
0<x<1 and 0<b≤1.2 are satisfied.

12. The positive electrode material according to claim 1, wherein
the M1 includes Al and at least one selected from the group consisting of Mg and Zr.

13. The positive electrode material according to claim 1, wherein
the positive electrode active material includes a material having properties of occluding and releasing lithium ions.

14. The positive electrode material according to claim 1, wherein
the positive electrode active material includes lithium nickel cobalt manganese oxide.

15. A battery comprising:
a positive electrode;
a negative electrode; and
an electrolyte layer disposed between the positive electrode and the negative electrode, wherein
the positive electrode includes the positive electrode material according to claim 1.

16. The battery according to claim 15, wherein
the electrolyte layer includes, as a third electrolyte, a material having the same composition as composition of the first electrolyte.

17. The battery according to claim 15, wherein
the electrolyte layer includes, as a third electrolyte, a material having composition different from composition of the first electrolyte.

18. The battery according to claim 15, wherein
the electrolyte layer includes a first electrolyte layer and a second electrolyte layer, the first electrolyte layer is disposed between the positive electrode and the negative electrode, and
the second electrolyte layer is disposed between the first electrolyte layer and the negative electrode.

19. The battery according to claim 18, wherein
the first electrolyte layer includes, as a third electrolyte, a material having the same composition as composition of the first electrolyte.

20. The battery according to claim 18, wherein
the second electrolyte layer includes, as a third electrolyte, a material having composition different from composition of the first electrolyte.
